(19) United States
(12) Patent Application Publication
(10) Pub. No.: US 2003/0204702 A1
(43) Pub. Date: Oct. 30, 2003

(54) Flexible memory architecture for an embedded processor

(75) Inventors: Charles Weston Lomax JR., Raleigh, NC (US); Melvin Richard Phillips, Raleigh, NC (US); Jefferson Logan Holt SR., Wake Forest, NC (US); James Xavier Torok, Raleigh, NC (US)

Correspondence Address: Fogg Slifer Polglaze Leffert & Jay, P.A., P.O. Box 581009, Minneapolis, MN, 55458-1009, US

(73) Assignee: ADC DSL Systems, Inc.

(21) Appl. No.: 10/137,247

(22) Filed: Apr. 30, 2002

(51) Int. Cl. G06F 12/00

(52) U.S. Cl. 711/207; 711/202; 711/142

(57) ABSTRACT

A method of operating a processing device is provided. The method includes defining an effective memory address space with a cached address space and a non-cached address space wherein the cached address space and the non-cached address space each translate to overlap a single physical memory space. Further, the method includes accessing a memory address of the physical memory space without accessing a cache memory system from the non-cached effective address space. The method also includes accessing a memory address of the physical memory space from the cached effective address space with the benefit of the cache memory system.

### TECHNICAL FIELD

The present invention relates generally to memory management in computer systems and embedded processing devices and in particular the present invention relates to memory management in computer systems and embedded processing devices with a memory management unit (MMU).

### BACKGROUND

Modern computer based systems are typically constructed of multiple differing devices, elements, or links, referred to collectively herein as elements. These systems also typically include internal computer systems and/or embedded processing devices, referred to collectively herein as processing devices, that operate to enable the computer based system to accomplish a given task that it has been designed for. Computer based systems also typically contain memory systems for use as internal storage areas for the processing devices that are comprised of one or more types of memory devices.

In many situations the computing system runs a single integrated process that controls all actions of the processing device(s) in the computer based system. In others, an operating system (OS) or executive program controls execution on the processing device(s) and allows for sub-processes to execute on the architecture of the computing system. The integrated process, executive program, or OS executing on a processing device(s) of a computer system are referred to collectively herein as an OS.

Many modern processing devices also utilize a fast local memory, called a cache, to hold recently accessed data from the memory system to speed up subsequent accesses to the same data or code instead of re-accessing main memory. It is noted that there are many types and forms of cache memory structures, utilization, and access methods and which will be generally known to those skilled in the art. A cache system can greatly reduce the memory access overhead and significantly increase the overall speed of execution of a given processing device. The following therefore is intended as an overview of caching in general and not as a detailed explanation.

Unlike cache read accesses, write accesses pose an additional problem for a caching system in that the updated data must eventually be copied back into the main memory system so that the main memory reflects the changed data state. Two common caching methodologies of handling this issue are called the write-through method and the write-back method. In the write-through method write accesses are written to both the cache and to the main memory system. In the write-back method the updated data is initially only written to the cache memory structure and then written to the main memory system only when the memory address is removed from the cache. As the updated memory locations are constantly being written, write-through caching will perform significantly slower than write-back caching and is generally seen as less desirable.

Memory management is generally pre-configured into the system or is performed automatically by hardware and/or OS of the computer based system. One such hardware element used in memory management of the memory contained in a computer based system is a memory management unit (MMU). A MMU is a hardware device or circuit that helps support memory management allowing for restriction of memory block or page uses and policies, translation of effective addresses into physical addresses, and keeps track of other valuable memory usage information. Many MMU's also allow physical memory areas or blocks to be redefined so that they appear in a differing location in the physical memory address space or can be accessed from multiple effective addresses (i.e., defining them multiple times in the effective memory address space). MMUs can define an effective address space that it differs in size and configuration from the actual physical memory being referenced. MMUs are typically integrated into individual processing devices of a modern computer based system, but have been separate elements of computer based system in the past.

A MMU translates an effective memory address to a physical memory address, by masking off or subtracting the effective base address of the effective address and adding or logically OR-ing a physical memory base address to the remaining effective base address offset to generate the physical address. To assist in address translation a MMU typically contains a listing of the base addresses of effective address “pages” and the corresponding base addresses of physical memory blocks called a page table. Each entry from the page table is combined with the page offset of the requested effective address to give the physical memory address to be accessed. The entries of a page table do not have to each point to a physical memory block of a uniform size. The page entries of an MMU can typically define a limited set of physical memory block sizes allowing the designer or programmer some flexibility in their use. An individual entry in a page table may also include information about whether the page has been written to, when it was last used, what process may access the page, or kind of processes (user mode, supervisor mode) may access the page, and whether the memory page is cacheable by the processor.

As page tables can contain a large amount of information and can be physically quite large, many MMU's utilize an alternative form of the page table called a translation look aside buffer (TLB). TLBs operate as a form of page table cache, where the full table is kept off the MMU in memory or other storage location or is generated from configuration information. An MMU's TLBs store the page table entries of recently utilized effective memory addresses for future accesses to the memory. This allows follow on accesses to the physical memory address represented by the effective memory address via the page table entry cached by the TLB. However, as the TLBs of a MMU are typically limited in number, the MMU must clear and replace the page table entries cached by the TLBs as the effective addresses being accessed change. This is accomplished by a process called a “tablewalk” in which the processing device or MMU “walks” a table data structure to calculate and fill the selected TLB or page table when an effective address translation is requested and the translation is not cached in a TLB or page table. Tablewalking is a relatively slow process and therefore is typically minimized wherever possible.

A problem with effective memory space addressing in modern computer systems and/or embedded processing devices is that in many situations the computer system or embedded processing device must write or read data in a non-cached manner from the physical memory address space. In many cases this is due to the physical address space containing “memory mapped” system elements that have their interfaces and/or buffer spaces mapped into the physical memory address space of the system. In these situations a processing device that utilizes a cache of recent memory accesses can cause complications in working and interfacing with the memory mapped system elements in that the memory accesses utilized in such communication can be internalized in the processing device's cache and will not be communicated to the physical memory system or a physical memory mapped system element and instead can be written only to the cache. Additionally, changes in the physical memory system or a physical memory mapped system element will not be reflected or “received” by the processor if a memory read access by the processing element occurs from the cache instead of from the memory system or memory mapped system element.

The most basic approach to this problem is to disable caching in the processing device or to only enable write-through caching. Unfortunately, as stated above, caching can have a large impact on processing device performance and disabling caching can lead to problems in computer based systems where performance is of issue.

An additional approach to solving the problem of memory caching with memory mapped system devices is to define an effective memory address space as cacheable, non-cacheable, or write-through cacheable as needed for processor only use, non-cached communication use, or write-only use. Unfortunately in many embedded processing devices the number of TLBs or page table entries are limited so that the MMU quickly runs out of available TLBs or page table space for entries and must start replacing the entries when a new effective memory area must be accessed. An additional factor that aggravates this problem is the fact that many TLBs or page table entries only allow a limited number of defined memory page sizes which do not always match the needed use, leading to inefficient use of generally limited memory resources, mismatched page sizes, and complex TLB or page table configurations.

In many cases the above problems with caching and memory management require that a processing device that is more powerful or has more MMU resources than strictly required is utilized in a computer based system so as to be able to guarantee a minimum processing ability and throughput. This however can increase the production costs, parts costs, and/or power requirements of the computer based device.

For the reasons stated above, and for other reasons stated below which will become apparent to those skilled in the art upon reading and understanding the present specification that there is a need in the art for a method and apparatus of conveniently managing memory address space in a processing device in a caching and non-caching manner and interfacing with memory mapped system elements.

### SUMMARY

The above-mentioned problems with conveniently managing memory address space in a processing device in a caching and non-caching manner and interfacing with memory mapped system elements are addressed by embodiments of the present invention and will be understood by reading and studying the following specification.

In one embodiment, a method of operating a processing device comprises defining an effective memory address space with a cached address space and a non-cached address space wherein the cached address space and the non-cached address space each translate to overlap a single physical memory space, accessing a memory address of the physical memory space without accessing a cache memory system from the non-cached effective address space, and accessing a memory address of the physical memory space from the cached effective address space with the benefit of the cache memory system.

In another embodiment, a method of operating a computer based system comprises accessing a memory address of a physical memory system with a processing device from a cached effective address space, wherein the effective address space and a non-cached effective address space are translate to overlap the same physical address space of the physical memory system, accessing a memory address of the physical memory system with the processing device without accessing a cache memory system from the non-cached effective address space, and accessing a memory address of the physical memory system with at least one system device.

In yet another embodiment, a machine-usable medium having machine-readable instructions stored thereon for execution by a processor to perform a method. The method including defining an effective memory address space with a cached address space and a non-cached address space wherein the cached address space and the non-cached address space each translate to overlap a single physical memory space, accessing a memory address of the physical memory space without accessing a cache memory system from the non-cached effective address space, and accessing a memory address of the physical memory space from the cached effective address space with the benefit of the cache memory system.

In a further embodiment, a method of operating a memory system comprises configuring an effective memory address space with a cached address space and a non-cached address space wherein the cached address space and the non-cached address space each translate to overlap the same address space of a physical memory system, accessing a memory address of the physical memory system with a processing device from the non-cached effective address space, wherein the data of the memory access is shared with at least one system device, and accessing a memory address of the physical memory system with a processing device from the cached effective address space, wherein the data of the memory access is used only by the processing device.

In yet a further embodiment, a method of operating a communication device comprises defining an effective memory address space with a cached address space and a non-cached address space wherein the cached address space and the non-cached address space each translate to overlap a single physical memory space, accessing a memory address of the physical memory space from the non-cached effective address space with a processing device, and accessing a memory address of the physical memory space from the cached effective address space with the processing device.

In another embodiment, a memory system comprises a physical memory system with a physical memory address space, a memory management unit (MMU), wherein the MMU defines a cached effective address space and a non-cached effective address space, and wherein the cached effective address space and the non-cached effective address space are mapped by the MMU to overlap the same physical memory address space.

In yet another embodiment, a computer based system comprises an embedded processing device, a memory system with a physical memory address space, at least one system device coupled to the memory system, a memory management unit (MMU) coupled to the embedded processing device and the memory system, wherein the MMU defines a cached effective address space and a non-cached effective address space, and wherein the cached effective address space and the non-cached effective address space are mapped by the MMU to overlap the same physical memory address space.

In a further embodiment, a communication device comprises at least one communication interface, an embedded processing device, a memory system with a physical memory address space, at least one system device coupled to the memory system, a memory management unit (MMU) coupled to the embedded processing device and the memory system, wherein the MMU defines a cached effective address space and a non-cached effective address space, and wherein the cached effective address space and the non-cached effective address space are mapped by the MMU to overlap the same physical memory address space.

Other embodiments are described and claimed.

### BRIEF DESCRIPTION OF THE DRAWINGS

FIGS. 1 and 2 are simplified diagrams of an effective memory address space mapped to a physical address space of a computer based system according to one embodiment of the present invention.

FIG. 3 is a simplified diagram of a Motorola MPC850 microcontroller processing device of an embodiment of the present invention.

FIGS. 4A and 4B are simplified diagrams of a MPC850 MMU TLB address translation circuit and a TLB address translation flowchart.

FIGS. 5 and 6 are simplified diagrams of an effective memory address space mapped to a physical address space of a MPC850 computer based system according to one embodiment of the present invention.

FIG. 7 is a simplified diagram of one embodiment of the present invention.

### DETAILED DESCRIPTION

In the following detailed description, reference is made to the accompanying drawings that form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims.

As stated above, conveniently managing cacheable and non-cacheable memory address space in a computer based system with memory mapped system elements or communication buffer space is an involved task for computer based devices and embedded processors. The necessity to not cache memory accesses or utilize write-through caching by a processing device to memory mapped systems or communication buffers can require that a processing device that is more powerful than strictly required is utilized so as to be able to guarantee a minimum processing ability and throughput in the particular computer based system, increasing system cost and/or power requirements. If effective memory address spaces are utilized to allow cacheable and non-cacheable address spaces for processor use and memory mapped system use, so as to gain the most performance possible out of the processing device via caching, the resulting effective memory address space can be complex and quickly exhaust the limited memory management unit (MMU) TLB or page table resources of many lower cost processing devices leading to the performance limiting tablewalking procedure as new TLB or page table contents are located and filled. Additionally, many TLBs or page table entries are limited in the range of memory block sizes they can refer to, leading to inexact matches to cacheable and non-cacheable memory spaces and blocks and the potential inefficient use of typically limited embedded application memory resources. These MMU problems can again lead to the necessity of utilizing a processing device that has more MMU resources and ability than is needed by processing requirements to be able to guarantee a minimum of MMU capability, processing ability, and throughput in the particular computer based system, adding to costs and system complexity. The complex and involved effective memory address spaces that result from this also do not always easily map to the underlying physical memory and can lead to much programmer confusion and misconfiguration of the resulting computer based system. Such misconfiguration can result in loss of service for the customer, delayed production schedules for the manufacturer, and/or may require field servicing or software updates to fix the misconfigured computer based device.

Embodiments of the present invention utilize an improved memory addressing architecture and method that allows simultaneous and equal access to a physical memory address space or section of physical address space by a processing device of a computer based system in both a caching and non-caching manner with a minimum of memory management resources. This enables easy and arbitrary definition and use of cacheable and non-cacheable memory space in a memory system by a processing device(s) of the computer based system and allows non-cacheable interaction, buffering, and communication to occur with memory mapped system elements and special purpose processors while allowing for the full throughput ability of the processor.

Embodiments of the present invention create an effective address space that contain two or more copies of an underlying physical address space or section of address space where one section of the effective address space that maps the underlying physical address space is defined as cacheable and the other is defined as non-cacheable. This allows the arbitrary use of any address in the physical address space in a caching or non-caching manner regardless of TLB or page table block size limitations of the MMU or processing device with a simple configuration of the OS, process, or sub-process that is to be run on the computer based system to use one or the other effective address space and areas within the effective address space for specified tasks. Additionally, embodiments of the present invention utilize only two TLBs or page table entries to map each physical address space in the definition of the effective memory area, conserving MMU resources and allowing the use of lower cost, more limited processing devices. This simplifies the resulting effective address space and software configuration, better ensuring proper configuration of the computer based system or processing device performing accesses on the memory system. This decreases potential loss of service outages and software updates and increases programmer efficiency and production schedules.

An alternative embodiment of the present invention will create a physical address space or real address space that maps an associated physical memory system two or more times into the physical address space where one address space is cacheable and the other is defined as non-cacheable by a processing device. This is accomplished by mapping the address space of the physical memory system two or more times in the physical address space of a configurable bus interface unit (BIU) or system interface unit (SIU) of a processing device. Alternatively, a physical memory system or physical memory device is addressed by more address lines or address bits than are required. The physical memory system ignores the extra most significant bits of an address being accessed by a processing device, mapping the physical memory two or more times into the physical address space. Either approach allows the physical memory system to be mapped two or more times into the physical address space. Additionally, these embodiments allow system elements and processors that do not have access to MMU facilities to access the larger remapped address space and avoid the need for effective address translation in the MMU, removing a level of address abstraction.

As also stated above, many computer based systems also contain memory systems for use as internal storage areas for system processing devices that are comprised of one or more types of memory devices. Common memory devices include, but are not limited to RAM (random-access memory), Static RAM (SRAM), Dynamic RAM (DRAM), synchronous DRAM (SDRAM), double data rate SDRAM (DDR-SDRAM), read-only memory (ROM), electrically erasable programmable read-only memory (EEPROM), Flash memory, and one-time programmable (OTP). Most RAM memory types are volatile, which means that they require a steady flow of electricity to maintain their contents, whereas ROM, Flash, and OTP memory types are non-volatile.

Communication device software routines that initialize and operate a computer based system are collectively referred to as firmware or ROM after the non-volatile ROM machine usable storage device that such routines have historically been stored in. It is noted that such firmware or ROM routines are stored on a variety of machine usable storage mediums that include, but are not limited to, a non-volatile Flash memory, a ROM, a EEPROM, a OTP device, a complex programmable logic device (CPLD), an application specific integrated circuit (ASIC), a magnetic media disk, etc. It is also noted that computer based systems can take multiple other physical forms, including, but not limited to, computer based systems that are functions of other systems, or elements that have functionality expressed in firmware or even hard-coded in a device such as an ASIC chip.

An example of such computer based systems are communication devices that connect networks and other elements across a link. Links can be virtual links that connect through other communication devices or physical links that connect across physical wire, cables, wireless, or optical connections. Links can be of multiple protocols and physical connections and signaling methods. Telecommunication devices are specialized communication devices that connect networks and elements across links that are part of a telecommunications or phone system. Examples of such include, but are not limited to, asynchronous transfer mode (ATM) links, digital subscriber line (DSL), ethernet links, modems, token ring, network hubs, network switches, wide area network (WAN) bridges, integrated services digital network (ISDN) devices, T1 termination units, etc. It is noted that other computer based systems containing processing devices, in addition to the referred to communication devices, are available and should be apparent to those skilled in the art.

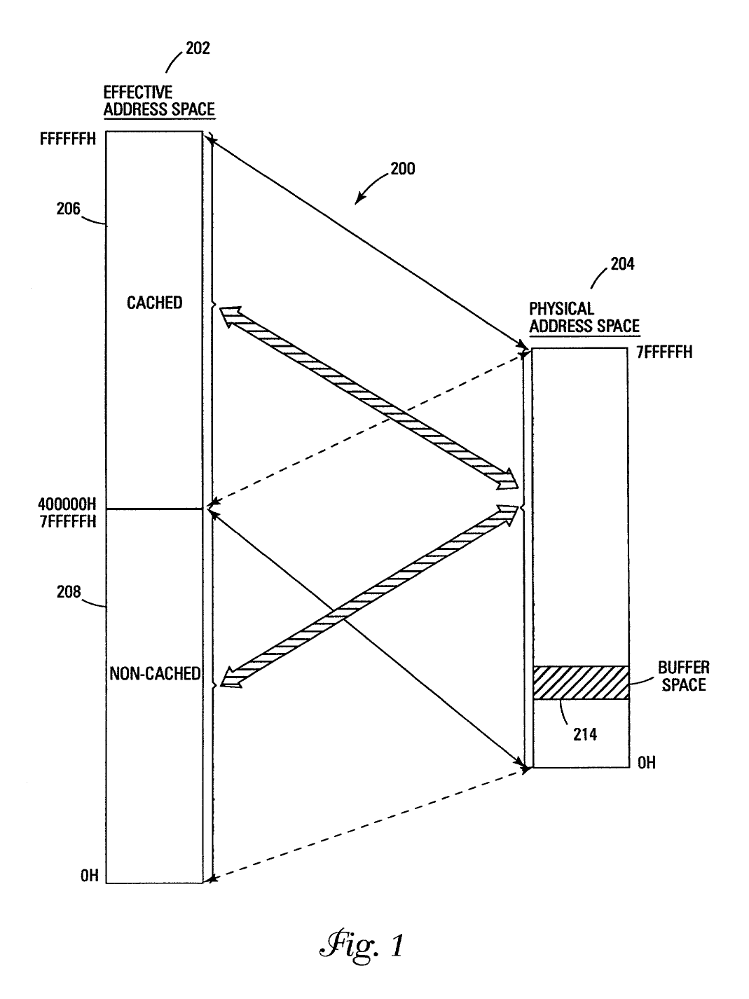

FIG. 1 is a simplified diagram of an effective address space to physical address space mapping of a MMU of a computer based system (not shown) according to one embodiment of the present invention. Unlike existing systems which define a new effective memory page for each specific use of a section of physical address space, embodiments of the present invention define a limited number of effective memory pages that overlap so that arbitrary access to the differing use sections of physical address space can occur with differing addressing of the OS or sub-process operating on the processing device, avoiding the need for large numbers of MMU resources and allowing the processor to operate at high throughput by utilizing caching wherever it is allowable and by avoiding MMU tablewalking to load new page table entries or TLB contents. In FIG. 1, memory map 200 of the computer based system contains an effective address space 202 that is defined twice as large as a physical address space 204 by a MMU (not shown). The MMU maps the effective address space 202 of 16 megabytes to a physical address space 204 of 8 megabytes. The effective address space is defined in two pages, one effective memory page is cacheable 206 by the processing device, the other non-cacheable 208. Both the cacheable effective memory page 206 and the non-cacheable effective memory page 208 map to the full physical address space 204 which contains buffer address space 212.

In operation, this allows processing device(s) of embodiments of the present invention to access memory mapped system elements, buffer spaces, and other non-cacheable memory access reads and write operations through the non-cacheable memory page 208. Cacheable memory accesses occur in the cacheable effective memory address space page 206 allowing the processor to operate at full potential throughput. The memory architecture also allows arbitrary usage of the physical memory space regardless of the size restrictions of the MMU page table entries or TLBs. This leads to more efficient use of the physical memory by avoiding waste due to mismatch of the page table entries or TLBs to the non-cacheable portions of the physical address space 204, such as the buffer areas 212. The memory architecture additionally allows programming configuration and linker definition files of programming language compliers or assemblers to easily define and control cacheable and non-cacheable memory accesses and code simply defining the code or a base address to be in one or the other effective memory space 206, 208. This simplifies memory management of processing device(s) and memory systems of embodiments of the present invention, reducing the potential for configuration error and lending itself to quick reconfiguration and reprogramming for new or updated tasks that the computer based device may be utilized with. Embodiments of the present invention also conserve limited MMU page table or TLB resources and avoid the time expensive and complex process of tablewalking to replace page table or TLB contents with a new required effective memory page. This allows a lower cost processing device to be utilized in the computer based system that more closely matches the exact processing needs, lowering costs and potentially simplifying production.

It is noted that other forms of caching (i.e., write-through caching) or other forms of page table or TLB restrictions can be utilized with embodiments of the present invention. It is also noted that additional effective memory pages can be defined that point to the same physical address space, allowing other page definitions and caching techniques to occur with a minimum additional use of page table resources or TLBs.

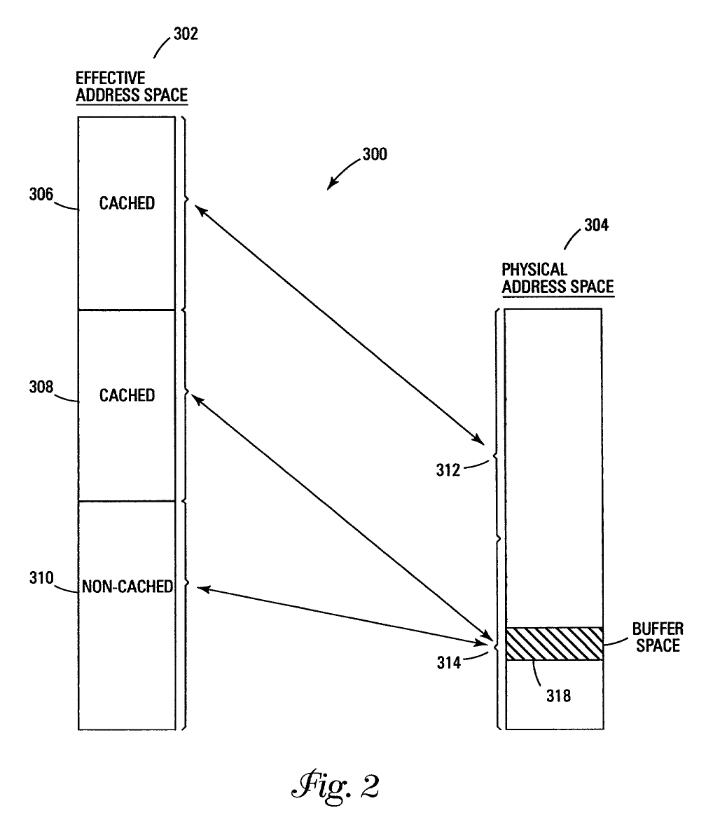

FIG. 2 is a simplified diagram of an effective address space to physical address space mapping of a MMU of a computer based system (not shown) according to another embodiment of the present invention. In FIG. 2, memory map 300 of the computer based system contains an effective address space 302 that includes a cacheable effective memory page 306 that directly maps to a physical memory page 312 of the physical address space 304 by a MMU (not shown). The memory map 300 also includes a cacheable effective memory page 308 and a non-cacheable memory page 310 that are both mapped to the same physical memory page 314 allowing cached and non-cached memory accesses to the physical memory page 314. The physical memory page 314 contains a buffer address space 318.

The memory map 300 of FIG. 2 allows for the same benefit of caching and non-caching access to the physical memory page 314 that is doubly mapped into the effective address space 302 in effective address pages 308 and 310 as the embodiment of FIG. 1, but additionally allows more flexibility in the definition of the doubly mapped address space by allowing whichever available convenient page size that is permitted by the MMU to overlap on a single section of the physical memory address space and not have to match the whole physical memory address space. This approach, however, requires a slightly higher number of page table entries or number of MMU TLBs to implement and may complicate processor initialization if the MMU is accessed on power-up before it is configured.

It is noted that a physical memory page 314 can be triply or multiply mapped into the effective address space 302 to allow additional addressing modes and that, while the overlapped effective address pages map to and overlap in the same general physical address space, they need not map to a physical address space of the same size. It is also noted that other embodiments of the present invention can contain one or more of these doubly or multiply overlapped pages in the resulting effective address space 302.

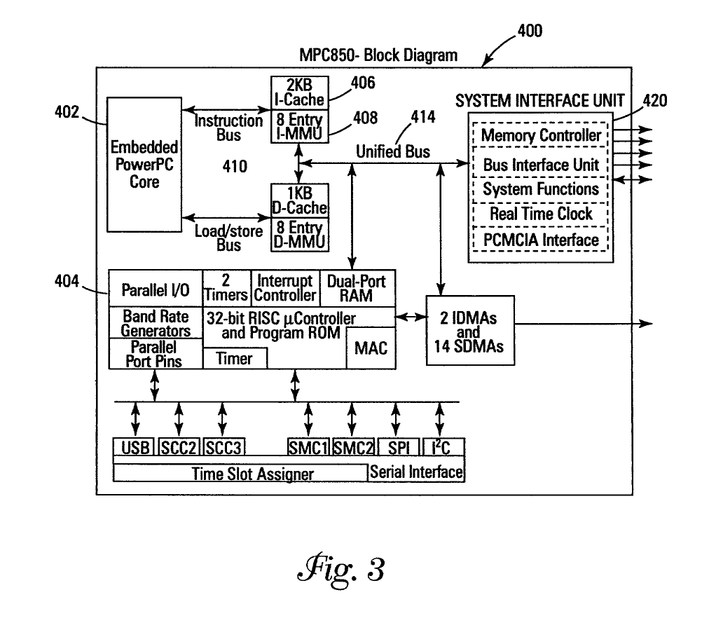

FIG. 3 is a simplified diagram of a MPC850 PowerPC processor from Motorola, Inc. of Schaumburg, Ill. In FIG. 3, the MPC850 400 contains an embedded processor core 402 and a specialized RISC communications processor 404. The processor core 402 is “Harvard” architecture and has separate instruction and data busses with separate 2 kilobyte instruction cache 406 and instruction MMU 408 and 1 kilobyte data cache 410 and data MMU 412. Both the instruction MMU 408 and the data MMU 412 contain 8 TLB entries each. The instruction MMU 408 and the data MMU 412 are coupled to an internal unified bus 414 that couples the MMUs 408, 412 to a memory mapped dual port RAM 416 of the RISC communications processor 404, a memory mapped DMA controller 418 that couples to external communication systems and the RISC communications processor 404, and a memory mapped system interface unit 420. The system interface unit 420 contains a memory controller and bus interface unit that couples the internal unified bus 414 to external memory and external systems. The system interface unit 420 also contains other functions, such as a real time clock and PCMCIA interface.

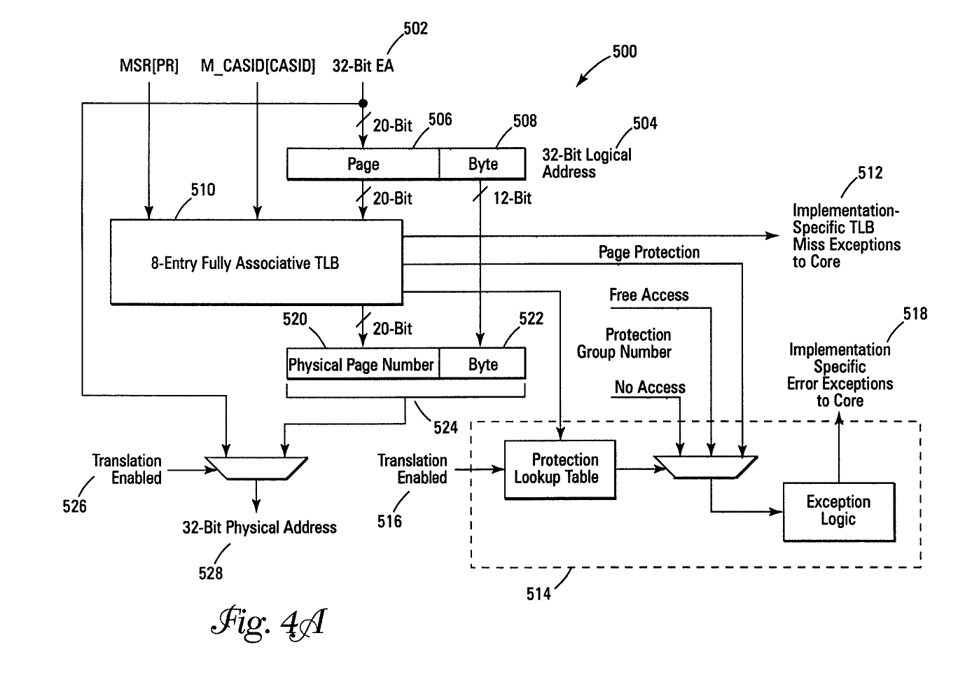

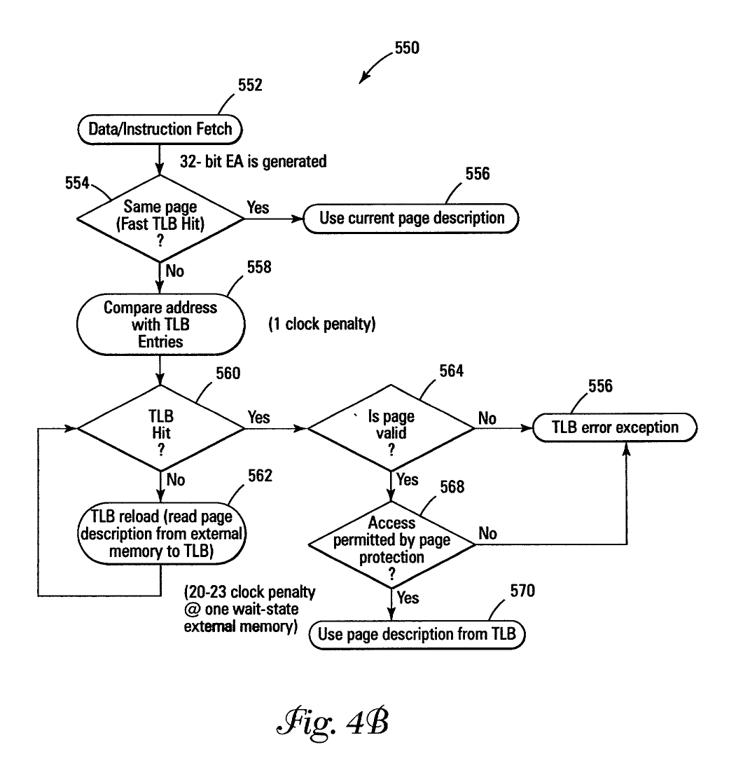

FIG. 4A is a simplified diagram of a MMU TLB address translation circuit 500 of the MPC850 instruction MMU 408 or data MMU 412. In FIG. 4A, the MMU receives a 32-bit effective address 502 from the processor core 402. The 32-bit effective address is registered 504 and divided into a 20-bit effective address page number 506 and 12-bit byte offset 508. The 20-bit effective address page number 506 is compared against the 8 entry fully associative TLB table 510 of the MMU. If no TLB is matched a TLB miss exception 512 is sent to the processor core 402 to note the problem and start the tablewalk procedure. If a TLB match is found to the effective address page number 506 page protection information is noted and sent to the page protection lookup table and exception logic circuit 514, where if page protection is enabled 516, page protection exceptions 518 are sent to the processor core 402 if a memory page access violation is triggered by the effective address page number 506 of the 32-bit effective address 502 and process. The 8 entry fully associative TLB table 510 provides a 20-bit physical address page number 520 if a TLB match is found for the 20-bit effective address page number 506. The 20-bit physical address page number 520 is then merged with the 12-bit byte offset 508, 522 to form a 32-bit physical address 524. Address MUX 528 then couples the 32-bit effective address 502 or the translated 32-bit physical address 524 to the memory system 528, if address translation is disabled or enabled 526 in the MMU. The MMU of the MPC850 allows for the definition of and effective address translation of 4 kilobyte (Kb), 16 Kb, 512 Kb, or 8 megabyte (Mb) memory pages.

FIG. 4B is a simplified flowchart 550 of the operation of MMU TLB address translation circuit 500. In the flowchart 550 of FIG. 4B, the MMU receives a 32-bit effective address data or instruction fetch 552 from the processor core 402. If the instruction fetch is from the same page as the previous instruction fetch 554 the current page description is used 556 and generates the physical address and accesses the memory system. If the instruction fetch is not from the same page the effective address is compared 558 against the other TLB entries of the MMU. If a match is not found in the current TLB entries of the MMU, the page table entry is loaded 562 from external memory in a tablewalk process. If a TLB hit is found, or the appropriate TLB is loaded from external memory into a TLB, the TLB page entry is then checked to see if the page is valid 564. If the page is valid, the page protection of the page entry is checked to see if access is permitted 568. If the page is not valid or if access is not permitted by page protection, a TLB error exception 566 is sent. If the page is valid and the access is permitted the TLB page description is used 570 to generate the 32-bit physical address and access the memory system.

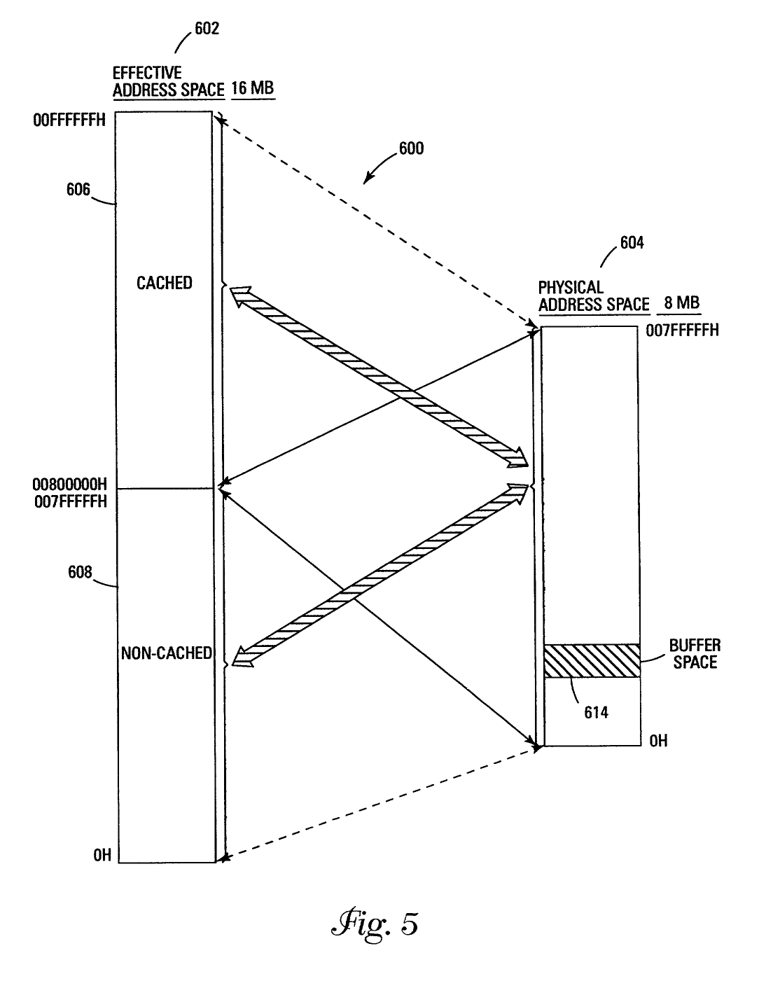

FIG. 5 is a simplified diagram of an effective address space to physical address space mapping of a MMU of a MPC850 based system (not shown) according to one embodiment of the present invention. In FIG. 5, memory map 600 of the computer based system contains a 16 megabyte effective address space 602 that is defined twice as large as a 8 megabyte physical address space 604 by the MPC850's instruction and/or data MMUs (not shown). The effective address space is defined in two 8 megabyte pages, one 8 megabyte effective memory page is cacheable 606 by the MPC850 processor core data or instruction caches, the other 8 megabyte effective memory page is non-cacheable 608. Both the 8 megabyte cacheable effective memory page 606 and the 8 megabyte non-cacheable effective memory page 608 map to the full 8 megabyte physical address space 604 which contains memory buffers shared by the processor core and system elements, such as DMA controller and the RISC communications processor 614.

In operation, this allows MPC850 processing device of the embodiment of the present invention to access the memory mapped buffers used by the RISC communication processor, and other non-cacheable memory access reads and write operations through the 8 megabyte non-cacheable memory page 608. Cacheable memory accesses occur in the 8 megabyte cacheable effective memory address space page 606 in areas not utilized by the memory mapped system elements 610, 612, buffers, or RISC communication processor 614, allowing the MPC850 processor core to operate at full potential throughput. The memory architecture also allows arbitrary usage of the full range of the 8 megabyte physical memory space regardless of the MPC850's MMU TLB memory page size restrictions. This leads to more efficient use of the physical memory by avoiding waste due to mismatch of the TLB page table entries to the available portions of the physical address space 604. The memory architecture additionally allows programming configuration and linker definition files to easily define and control cacheable and non-cacheable memory accesses and code simply defining the code addresses or a base address of the code segment to be in one or the other of the MPC850's effective memory space page tables 606, 608. This simplifies memory management of the MPC850 embodiments of the present invention, reducing the potential for configuration error and lending itself to quick reconfiguration and reprogramming for new or updated tasks that the MPC850 based device may be utilized with. Embodiments of the present invention also conserve the MPC850 limited 8 TLB entry MMU resources and avoid the time expensive and complex process of tablewalking to replace page table or TLB contents with a new required effective memory page. This allows the lower cost MPC850 processing device to be utilized in computer based systems instead of other more feature rich or faster members of the Motorola MPC8XX family that have more TLB entries in their MMUs or have more throughput, lowering overall costs, power requirements, and potentially simplifying production.

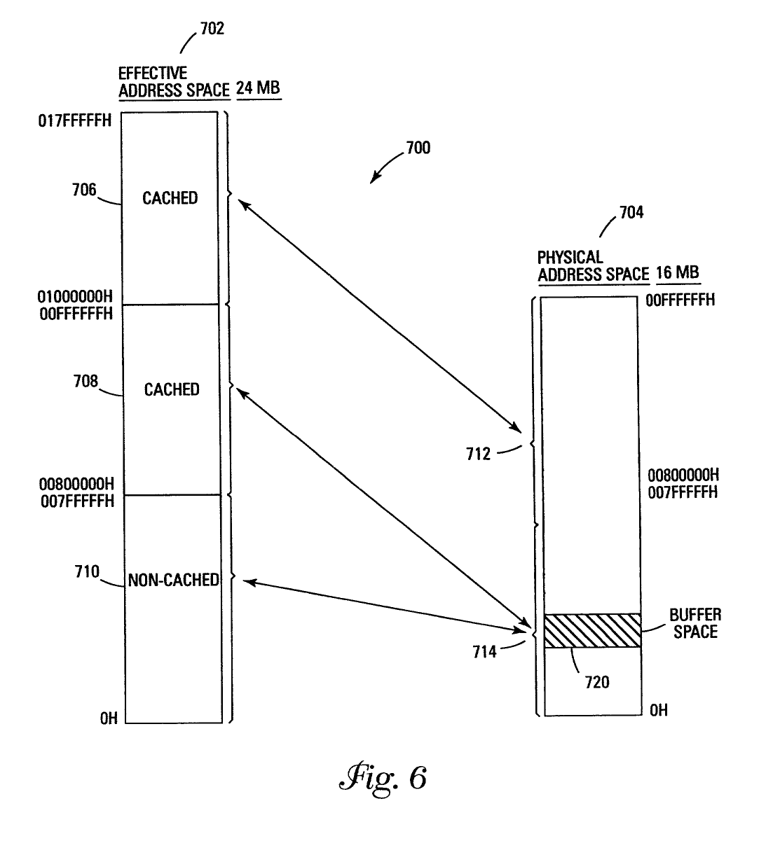

FIG. 6 is a simplified diagram of an effective address space to physical address space mapping of a MMU of a MPC850 processor based system (not shown) according to another embodiment of the present invention. In FIG. 6, memory map 700 of the MPC850 based system contains a 24 megabyte effective address space 702 that includes a 8 megabyte cacheable effective memory page 706 that directly maps to a 8 megabyte physical memory page 712 of a 16 megabyte physical address space 704 by the MPC850's instruction and/or data MMUs (not shown). The memory map 700 also includes a 8 megabyte cacheable effective memory page 708 and a 8 megabyte non-cacheable memory page 710 that are both mapped to the same 8 megabyte physical memory page 714, allowing cached and non-cached memory accesses to the physical memory page 714. The 8 megabyte physical memory page 714 contains memory buffer address space of the RISC communications processor 720.

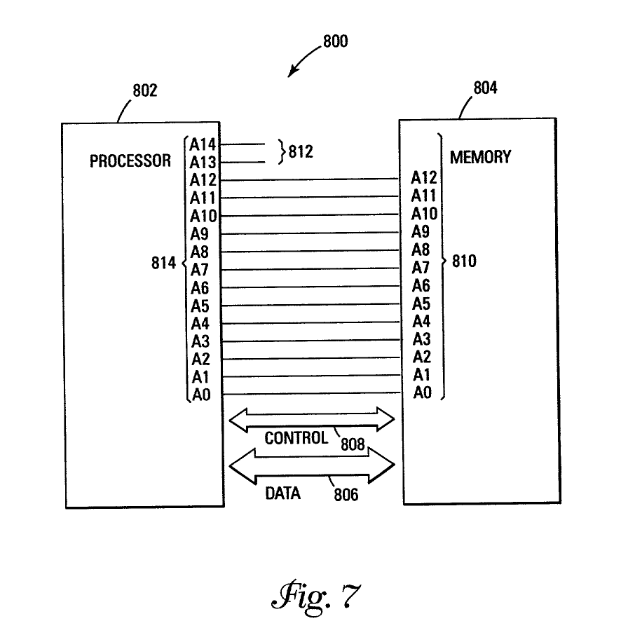

FIG. 7 is a simplified diagram of a computer base system 800 of one embodiment of the present invention. In FIG. 7, a processing device 802 and memory system or memory device 804 are coupled together by a data bus 806, a control bus 808, and an address bus 814 which contains two sections of address lines 810, 812. The least significant bits of an address expressed by the processing device 802 are placed on address lines (A12-A0) 810 of the address bus 814 and are coupled to the memory system 804. The most significant bits of an address expressed by the processing device 802 are placed on address lines (A14-A13) 812 of the address bus 814. Address lines (A14-A13) 812 of the address bus 814, however, are not coupled to or are not used by the memory system 804. Because of this the portion of the address expressed by the processing device 802 on address lines (A14-A13) 812 is ignored by the memory system 804 for memory accesses, mapping the address space of the memory system 804 accessed by the least significant bits of the address, address lines (A12-A0) 810, into the physical address space four times. This therefore allows each memory position in the memory system to be accessed from 4 different physical addresses without the need for effective address translation by a MMU. This approach allows other system elements (not shown) of the computer based system 800 to access the multiply mapped memory system 804 with the same address as the processor without the need for them to have an individual MMU. The number of times the memory system 804 is mapped into the physical address space of the computer based system 800 depends on the number of most significant address lines that are not utilized by the memory system in addressing and increase by a power of two for each additional address line 812. In these embodiments of the present invention the MMU is still utilized by the processor to mark individual copies of the memory system 804 that are mapped into the physical memory address space multiple times as cacheable, non-cacheable, or another memory characteristic. It is noted that a chip select line or decode logic circuit operating off of the most significant address lines 812 will allow the memory system 804 to be moved to an arbitrary base address or addresses within the physical memory address space of the computer based system 800.

It is also noted that many system interface units (SIUs) and/or bus interface units (BIUs) of modern processors 802 allow the same effect of multiple mapping of a physical memory system or device 804 into the physical address space by modifying their decoding of addresses before they are placed on external busses. Such multiple mapping of memory systems or devices 804 by different address decoding by a SIU or BIU is then available for internal devices and processor only.

It is further noted that multiple mapping or decoding of memory systems 804 can occur with external logic devices, such as a CPLD, a FPGA, or an ASIC, to allow multiple mapping without the need to drop address lines. It is also noted that such decoding or chip selects can allow the multiple mapping of the memory system 804 to be moved to an arbitrary base address or addresses within the physical memory address space of the computer based system 800.

It is also noted that other configurations of MPC850 based systems and devices incorporating embodiments of the present invention are possible and should be apparent to those skilled in the art with the benefit of the present disclosure.

Alternative computer based system embodiments of the present invention with an improved memory architecture and method will be apparent to those skilled in the art with the benefit of the present disclosure, and are also within the scope of the present invention.

### CONCLUSION

A flexible effective memory architecture and method have been described for operating a computer based system that allows a memory system that contains of cacheable and non-cacheable memory areas to be efficiently utilized by a processing device, while utilizing an effective address space that consumes a minimum of memory management unit (MMU) resources. The whole physical memory system or a portion of the physical memory system is mapped into a defined effective memory space twice by the MMU of the processing device; one effective address space copy of the physical memory is cacheable, the other is non-cacheable. The processing device memory accesses that can be cached are addressed to the cacheable effective address copy of the physical memory, while memory accesses that cannot be cached are addressed to the non-cacheable effective address space copy of the physical memory. Thus memory accesses and communications with memory mapped systems or processors that must not be cached occur in the non-cacheable memory address space, and cacheable memory accesses occur in the cacheable address space, allowing the processing device to operate at full potential and the address space to be configurably divided. These memory areas can be cacheable RAM or ROM, a memory mapped system, a communications buffer space, or another processor, and can be arbitrarily defined and/or placed in the physical memory address space.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method of operating a processing device, comprising:
defining an effective memory address space with a cached address space and a non-cached address space wherein the cached address space and the non-cached address space each translate to overlap a single physical memory space;
accessing a memory address of the physical memory space without accessing a cache memory system from the non-cached effective address space; and
accessing a memory address of the physical memory space from the cached effective address space with the benefit of the cache memory system.

2. The method of claim 1, wherein defining an effective memory address space with a cached address space and a non-cached address space wherein the cached address space and the non-cached address space each translate to overlap a single physical memory space further comprises defining an effective memory address space with a cached address space and a write-through cached address space wherein the cached address space and the write-through cached address space each translate to overlap a single physical memory space.

3. The method of claim 1, wherein defining an effective memory address space with a cached address space and a non-cached address space wherein the cached address space and the non-cached address space each translate to overlap a single physical memory space further comprises defining an effective memory address space with a cached address space and a write-through cached address space wherein the cached address space and the write-through cached address space are translated by an address decoder to overlap a single physical memory space of a memory system.

4. The method of claim 1, wherein defining an effective memory address space with a cached address space and a non-cached address space wherein the cached address space and the non-cached address space each translate to overlap a single physical memory space further comprises defining an effective memory address space with a cached address space and a write-through cached address space wherein the cached address space and the write-through cached address space are translated by one or more unutilized address lines to overlap a single physical memory space of a memory system.

5. The method of claim 1, wherein defining an effective memory address space with a cached address space and a non-cached address space wherein the cached address space and the non-cached address space each translate to overlap a single physical memory space further comprises defining an effective memory address space with a cached address space and a non-cached address space wherein the cached address space and the non-cached address space each translate to overlapping physical memory spaces that are of differing size.

6. The method of claim 1, wherein defining an effective memory address space with a cached address space and a non-cached address space wherein the cached address space and the non-cached address space each translate to overlap a single physical memory space further comprises defining an effective memory address space with a cached address space and a non-cached address space that are the same size.

7. The method of claim 6, wherein defining an effective memory address space with a cached address space and a non-cached address space further comprises defining an effective memory address space with a cached address space and a non-cached address space with two translation look-aside buffers (TLBs) of a memory management unit (MMU).

8. The method of claim 6, wherein defining an effective memory address space with a cached address space and a non-cached address space further comprises defining an effective memory address space with a cached address space and a non-cached address space with two page table entries in a memory management unit (MMU).

9. The method of claim 1, wherein defining an effective memory address space further comprises defining multiple pairs of cached and non-cached effective address spaces wherein each pair of cached and non-cached effective address spaces each translate to overlap a separate physical address space.

10. The method of claim 1, wherein defining an effective memory address space further comprises defining multiple effective address spaces of differing memory characteristics that each translate to overlap the same physical address space.

11. The method of claim 1, wherein defining an effective memory address space with a cached address space and a non-cached address space wherein the cached address space and the non-cached address space each translate to overlap a single physical memory space further comprises defining an effective memory address space that is twice as large as an associated physical address space.

12. The method of claim 1, wherein accessing a memory address of the physical memory space without accessing a cache memory system from the non-cached effective address space further comprises accessing a data buffer.

13. The method of claim 1, further comprising:
Configuring address use by the processing device in the cached and non-cached effective address space by configuring process addresses.

14. The method of claim 13, wherein accessing configuring process addresses further comprises configuring process base address definitions in a linker configuration file.

15. A method of operating a computer based system, comprising:
accessing a memory address of a physical memory system with a processing device from a cached effective address space, wherein the effective address space and a non-cached effective address space are translated to overlap the same physical address space of the physical memory system;
accessing a memory address of the physical memory system with the processing device without accessing a cache memory system from the non-cached effective address space; and
accessing a memory address of the physical memory system with at least one system device.

16. The method of claim 15, wherein accessing a memory address of the physical memory system with at least one system device further comprises accessing a memory buffer address space with the at least one system device in the physical memory system.

17. The method of claim 15, wherein accessing a memory address of a physical memory system with a processing device from a cached effective address space, wherein the effective address space and a non-cached effective address space are translated to overlap the same physical address space of the physical memory system further comprises accessing a memory address of a physical memory system with a processing device from a cached effective address space, wherein the effective address space and a non-cached effective address space are translated by an address decoder to overlap the same physical memory space of a memory system.

18. The method of claim 15, wherein accessing a memory address of a physical memory system with a processing device from a cached effective address space, wherein the effective address space and a non-cached effective address space are translated to overlap the same physical address space of the physical memory system further comprises accessing a memory address of a physical memory system with a processing device from a cached effective address space, wherein the effective address space and a non-cached effective address space are translated by one or more unutilized address lines to overlap the same physical memory space of a memory system.

19. The method of claim 15, further comprising:
defining an effective memory address space with a copy-back cached address space and a write-through cached address space.

20. The method of claim 15, further comprising:
defining an effective memory address space with a cached address space and a non-cached address space that are the same size.

21. The method of claim 15, further comprising:
defining an effective memory address space that is twice as large as an associated physical address space.

22. The method of claim 15, further comprising
defining an effective memory address space with a cached address space and a non-cached address space wherein the cached address space and the non-cached address space each translate to overlapping physical memory spaces that are of differing size.

23. The method of claim 15, wherein accessing a memory address of the physical memory system with at least one system device further comprises accessing a memory address with a processing element.

24. The method of claim 23, wherein accessing a memory address with a processing element further comprises accessing a memory address with a communication processor.

25. The method of claim 15, further comprising:
Configuring address use by the processing device in the cached and non-cached effective address space by configuring process addresses.

26. The method of claim 25, wherein accessing configuring process addresses further comprises configuring process base address definitions in a linker configuration file.

27. A machine-usable medium having machine-readable instructions stored thereon for execution by a processor to perform a method comprising:
defining an effective memory address space with a cached address space and a non-cached address space wherein the cached address space and the non-cached address space each translate to overlap a single physical memory space;
accessing a memory address of the physical memory space without accessing a cache memory system from the non-cached effective address space; and
accessing a memory address of the physical memory space from the cached effective address space with the benefit of the cache memory system.

28. The machine-usable medium of claim 27, wherein defining an effective memory address space with a cached address space and a non-cached address space wherein the cached address space and the non-cached address space each translate to overlap a single physical memory space further comprises defining an effective memory address space that is twice as large as an associated physical address space.

29. The method of claim 27, wherein defining an effective memory address space with a cached address space and a non-cached address space wherein the cached address space and the non-cached address space each translate to overlap a single physical memory space further comprises defining an effective memory address space with a cached address space and a write-through cached address space wherein the cached address space and the write-through cached address space are translated by an address decoder to overlap a single physical memory space of a memory system.

30. The method of claim 27, wherein defining an effective memory address space with a cached address space and a non-cached address space wherein the cached address space and the non-cached address space each translate to overlap a single physical memory space further comprises defining an effective memory address space with a cached address space and a write-through cached address space wherein the cached address space and the write-through cached address space are translated by one or more unutilized address lines to overlap a single physical memory space of a memory system.

31. The machine-usable medium of claim 27, wherein accessing a memory address of the physical memory space without accessing a cache memory system from the non-cached effective address space further comprises accessing a data buffer memory address space.

32. The machine-usable medium of claim 27, further comprising:
Configuring address use by the processing device in the cached and non-cached effective address space by configuring process addresses.

33. The machine-usable medium of claim 32, wherein accessing configuring process addresses further comprises configuring process base address definitions in a linker configuration file.

34. A method of operating a memory system, comprising:
configuring an effective memory address space with a cached address space and a non-cached address space wherein the cached address space and the non-cached address space each translate to overlap the same address space of a physical memory system;
accessing a memory address of the physical memory system with a processing device from the non-cached effective address space, wherein the data of the memory access is shared with at least one system device; and
accessing a memory address of the physical memory system with a processing device from the cached effective address space, wherein the data of the memory access is used only by the processing device.

35. The method of claim 34, further comprising:
accessing a memory address of the physical memory system with the at least one system device.

36. A method of operating a communication device, comprising:
defining an effective memory address space with a cached address space and a non-cached address space wherein the cached address space and the non-cached address space each translate to overlap a single physical memory space;
accessing a memory address of the physical memory space from the non-cached effective address space with a processing device; and
accessing a memory address of the physical memory space from the cached effective address space with the processing device.

37. The method of claim 36, wherein accessing a memory address of the physical memory space from the cached and non-cached effective address space with a processing device further comprises accessing a memory address of the physical memory space from the cached and non-cached effective address space with a MPC850 processor.

38. The method of claim 36, wherein defining an effective memory address space with a cached address space and a non-cached address space wherein the cached address space and the non-cached address space each translate to overlap a single physical memory space further comprises defining the effective memory address space twice the size of the physical memory, wherein the cached and non-cached effective address space are each the size of the physical memory.

39. The method of claim 36, wherein defining an effective memory address space with a cached address space and a non-cached address space wherein the cached address space and the non-cached address space each translate to overlap a single physical memory space further comprises defining the effective memory address space that contains multiple effective address spaces of differing memory characteristics that translate to overlap the same physical address space.

40. The method of claim 36, wherein defining an effective memory address space with a cached address space and a non-cached address space wherein the cached address space and the non-cached address space each translate to overlap a single physical memory space further comprises defining the effective memory address space that contains multiple effective address spaces of differing memory characteristics that translate to physical address spaces of differing size that overlap.

41. The method of claim 36, wherein defining an effective memory address space with a cached address space and a non-cached address space further comprises defining an effective memory address space with a cached address space and a non-cached address space by utilizing two translation look-aside buffers (TLBs) of a memory management unit (MMU) to hold page table definition entries for the cached and non-cached effective address spaces and translate from the effective address space to the physical address space.

42. The method of claim 36, wherein accessing a memory address of the physical memory space from the cached and non-cached effective address spaces with a processing device further comprises accessing a memory address of the physical memory space from the cached and non-cached effective address spaces by utilizing two translation look-aside buffers (TLBs) of a memory management unit (MMU) to hold page table definition entries for the cached and non-cached effective address spaces and translate from the effective address space to the physical address space.

43. The method of claim 36, further comprising:
Configuring address use by the processing device in the cached and non-cached effective address space by configuring operating system (OS) addresses.

44. The method of claim 43, wherein accessing configuring operating system (OS) addresses further comprises configuring operating system (OS) base address definitions in a linker configuration file of a compiler.

45. A memory system, comprising:
a physical memory system with a physical memory address space;
a memory management unit (MMU);
wherein the MMU defines a cached effective address space and a non-cached effective address space; and
wherein the cached effective address space and the non-cached effective address space are mapped by the MMU to overlap the same physical memory address space.

46. The memory system of claim 45, wherein the cached effective address space and the non-cached effective address space are defined by the MMU to each be the same size as the physical memory address space.

47. The memory system of claim 45, wherein the cached effective address space and the non-cached effective address space are defined by the MMU to map to overlapping physical memory address spaces of differing size.

48. The memory system of claim 45, wherein the cached effective address space and the non-cached effective address space are defined by an address decoder to overlap the same physical memory address space.

49. The memory system of claim 45, wherein the cached effective address space and the non-cached effective address space are translated by one or more unutilized address lines to overlap the same physical memory address space.

50. The memory system of claim 45, wherein the physical memory system is coupled to a processor.

51. The memory system of claim 45, wherein the memory system is coupled to a system device.

52. The memory system of claim 51, wherein the system device is a communication processor.

53. A computer based system, comprising:
an embedded processing device;
a memory system with a physical memory address space;
at least one system device coupled to the memory system;
a memory management unit (MMU) coupled to the embedded processing device and the memory system;
wherein the MMU defines a cached effective address space and a non-cached effective address space; and
wherein the cached effective address space and the non-cached effective address space are mapped by the MMU to overlap the same physical memory address space.

54. The computer based system of claim 53, wherein the cached effective address space and the non-cached effective address space are defined by the MMU to each be the same size as the physical memory address space.

55. The computer based system of claim 53, wherein the cached effective address space and the non-cached effective address space are mapped by an address decoder to overlap the same physical memory address space.

56. The computer based system of claim 53, wherein the cached effective address space and the non-cached effective address space are mapped by one or more unutilized address lines to overlap the same physical memory address space.

57. The memory system of claim 53, wherein the cached effective address space and the non-cached effective address space are defined by the MMU to map to overlapping physical memory address spaces of differing size.

58. The computer based system of claim 53, wherein the physical memory system is coupled to a processor.

59. The computer based system of claim 53, wherein the memory system is coupled to a system device.

60. The computer based system of claim 59, wherein the system device is a communication processor.

61. The computer based system of claim 53, wherein the MMU defines multiple effective address spaces that are each mapped by the MMU to the same physical memory address space.

62. The computer based system of claim 61, wherein the MMU defines each multiple effective address space with different memory management characteristics.

63. A communication device, comprising:
at least one communication interface;
an embedded processing device;
a memory system with a physical memory address space;
at least one system device coupled to the memory system;
a memory management unit (MMU) coupled to the embedded processing device and the memory system;
wherein the MMU defines a cached effective address space and a non-cached effective address space; and
wherein the cached effective address space and the non-cached effective address space are mapped by the MMU to overlap the same physical memory address space.

64. The computer based system of claim 63, wherein the embedded processing device is a MPC850 processor.

65. The computer based system of claim 63, wherein the cached effective address space and the non-cached effective address space are defined by the MMU to each be the same size as the physical memory address space.

66. The computer based system of claim 63, wherein the cached effective address space and the non-cached effective address space are defined by the MMU to map to overlapping physical memory address spaces of differing size.
